(19) United States
(12) Patent Application Publication
(10) Pub. No.: US 2025/0150485 A1
(43) Pub. Date: May 8, 2025

(54) INFORMATION PROVISION METHOD AND INFORMATION PROCESSING DEVICE

(71) Applicant: Panasonic Automotive Systems Co., Ltd., Kanagawa (JP)

(72) Inventors: Hideyo FUKUSHIMA, Kanagawa (JP); Jun HIDAKA, Kanagawa (JP); Junichi YOSHIDA, Kanagawa (JP); Eiyoshi NAKATSUJI, Kanagawa (JP); Masato ASANUMA, Fukuoka (JP)

(73) Assignee: Panasonic Automotive Systems Co., Ltd., Kanagawa (JP)

(21) Appl. No.: 19/016,703

(22) Filed: Jan. 10, 2025

Related U.S. Application Data
(63) Continuation of application No. PCT/JP2023/026470, filed on Jul. 19, 2023.

(30) Foreign Application Priority Data
Nov. 11, 2022 (JP) 2022-180736

(51) Int. Cl. H04L 9/40

(52) U.S. Cl. CPC H04L 63/1441; H04L 63/1416

(57) ABSTRACT

An information provision method is executed by an information processing device that: obtains attack information through communication with a security monitoring device that determines presence or absence of an attack based on log information obtained from a vehicle; and provides an instruction that causes an attacked vehicle to take a countermeasure appropriate to the attack. The information provision method includes: receiving attack information including a first function of a first vehicle targeted for an attack and vehicle information for identifying the first vehicle; and transmitting, to the first vehicle, an instruction that causes the first vehicle to take a countermeasure determined according to the first function, in which when the first function is a function included in one or more second functions, which are not a driving function of the first vehicle, the countermeasure includes a first countermeasure for disabling the first function while keeping the driving function active.

### CROSS REFERENCE TO RELATED APPLICATION

This is a continuation application of PCT International Application No. PCT/JP2023/026470 filed on Jul. 19, 2023, designating the United States of America, which is based on and claims priority of Japanese Patent Application No. 2022-180736 filed on Nov. 11, 2022.

### FIELD

The present invention relates to an information provision method and an information processing device.

### BACKGROUND

Patent Literature (PTL) 1 discloses a center device that integrates a plurality of pieces of information on a vehicle, which are obtained from the vehicle, and determines a state of the vehicle related to reprogramming data downloaded from a file server to a vehicle master device.

### CITATION LIST

### Patent Literature

PTL 1 Japanese Unexamined Patent Application Publication No. 2020-21135

### SUMMARY

### Technical Problem

However, the technology according to PTL 1 can be improved upon.

### Solution to Problem

An information provision method according to one aspect of the present disclosure is an information provision method executed by an information processing device that: obtains attack information through communication with a security monitoring device that determines presence or absence of an attack based on log information obtained from a vehicle; and provides an instruction that causes an attacked vehicle to take a countermeasure appropriate to the attack. The information provision method includes: receiving attack information from the security monitoring device, the attack information including a first function of a first vehicle targeted for an attack and vehicle information for identifying the first vehicle; and transmitting, to the first vehicle identified by the vehicle information, an instruction that causes the first vehicle to take a countermeasure determined according to the first function, in which when the first function is a function included in one or more second functions, which are not a driving function of the first vehicle, the countermeasure includes a first countermeasure for disabling the first function while keeping the driving function active.

It is to be noted that these general and specific aspects may be implemented using a system, a method, an integrated circuit, a computer program, or a computer readable non-transitory recording medium such as a CD-ROM, or any combination of systems, methods, integrated circuits, computer programs, or non-transitory recording media.

### Advantageous Effects of Invention

The above-described aspects are capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a schematic diagram illustrating an information provision system that provides information to a vehicle according to an embodiment.

FIG. 2 is a block diagram illustrating an example of a hardware configuration of an information processing device according to the embodiment.

FIG. 3 is a block diagram illustrating an example of a hardware configuration of the vehicle according to the embodiment.

FIG. 4 is a block diagram illustrating an example of a functional configuration of the information provision system according to the embodiment.

FIG. 5 is a table for describing an association between threat levels and types of security attacks.

FIG. 6 is a table showing an example of a counteracting rule for a first vehicle in operation targeted for a security attack.

FIG. 7 is a table showing an example of a counteracting rule for the first vehicle before operation (not in operation) targeted for a security attack.

FIG. 8 is a table showing an example of a counteracting rule about functions that are forcedly disabled in the event of a security attack at level B on the first vehicle in operation, the counteracting rule being set according to the administrator.

FIG. 9 is a table showing an example of a counteracting rule about functions that are forcedly disabled in the event of a security attack at level B on the first vehicle before operation (not in operation), the counteracting rule being set according to the administrator.

FIG. 10 is a diagram illustrating an example of placement of an interior display of the vehicle according to the embodiment.

FIG. 11 is a sequence diagram illustrating an example of an information provision method executed by the information provision system according to the embodiment.

FIG. 12 is a sequence diagram illustrating an example of an operation in recovery executed by the information provision system according to the embodiment.

FIG. 13 is a diagram illustrating an example of a user interface (UI) presented on the interior display according to a presentation instruction according to the embodiment.

### DESCRIPTION OF EMBODIMENT

### Underlying Knowledge Forming Basis of the Present Disclosure

In relation to the center device in the Background section, the inventors have found the following problem.

The technology described in PTL 1 visualizes and presents an anomalous situation of the vehicle to the user. However, only from the presentation of the anomalous situation of the vehicle to the user, the user cannot immediately determine whether the user can continue the operation of the vehicle, and can be confused.

In the event of a security attack, for example, the user may be able to continue the operation of the vehicle if the security attack has no impact on the driving functions of the vehicle. However, according to the prior art, the user cannot immediately determine whether the user can continue the operation of the vehicle and therefore has to halt the operation of the vehicle in order to prevent an unanticipated motion control.

As described above, when the security attack has no impact on the motion of the vehicle, it is desirable to continue the operation (motion) of the vehicle while avoiding the risk due to the security attack. There is also a problem that, during recovery to the normal state of the vehicle, the user does not know whether there is means of avoiding the risk of damage while continuing the operation of the vehicle.

As a result of intensive studies, the inventors have found an information provision method and the like that allow an attacked vehicle to continue operation (motion) when the attack has no impact on the driving functions of the vehicle.

An information provision method according to Aspect 1 of the present disclosure is an information provision method executed by an information processing device that: obtains attack information through communication with a security monitoring device that determines presence or absence of an attack based on log information obtained from a vehicle; and provides an instruction that causes an attacked vehicle to take a countermeasure appropriate to the attack. The information provision method includes: receiving attack information from the security monitoring device, the attack information including a first function of a first vehicle targeted for an attack and vehicle information for identifying the first vehicle; and transmitting, to the first vehicle identified by the vehicle information, an instruction that causes the first vehicle to take a countermeasure determined according to the first function, in which when the first function is a function included in one or more second functions, which are not a driving function of the vehicle, first the countermeasure includes a first countermeasure for disabling the first function while keeping the driving function active.

With this, when the first function of the first vehicle targeted for an attack is a function included in the one or more second functions, which are not the driving functions, the first vehicle can be caused to take a countermeasure for disabling the first function while keeping the driving function active.

An information provision method according to Aspect 2 of the present disclosure is the information provision method according to Aspect 1, in which the first countermeasure includes forcedly disabling the first function.

Thus, the risk due to the attack can be avoided.

An information provision method according to Aspect 3 of the present disclosure is the information provision method according to Aspect 2, in which the countermeasure further includes a second countermeasure that causes a presenter included in the first vehicle to present function information that indicates the first function.

Thus, the user can recognize the function disabled to avoid the risk due to the attack.

An information provision method according to Aspect 4 of the present disclosure is the information provision method according to Aspect 3, in which the second countermeasure further includes, after forcedly disabling the first function, causing the presenter to present a first user interface (UI) for receiving, from a user of the first vehicle via an input interface included in the first vehicle, an instruction for resuming the first function.

Thus, the user can continue using the attacked function while knowing the risk due to the attack.

An information provision method according to Aspect 4 of the present disclosure is the information provision method according to Aspect 1, in which the first countermeasure includes causing a presenter included in the first vehicle to present a second user interface (UI) for receiving, from a user of the first vehicle via an input interface included in the first vehicle, an instruction for disabling the first function.

Thus, the user can choose whether to disable the attacked function or not.

An information provision method according to Aspect 6 of the present disclosure is the information provision method according to Aspect 5, in which the first countermeasure further includes, after disabling the first function, causing the presenter to present a third user interface (UI) for receiving, from the user of the first vehicle via the input interface, an instruction for resuming the first function.

Thus, the user can choose to resume the attacked function.

An information provision method according to Aspect 7 of the present disclosure is the information provision method according to Aspect 5 or 6, in which the second UI further includes risk information for presenting a risk in a case where the first function is not disabled.

Thus, the user can recognize the risk due to the attack.

An information provision method according to Aspect 8 of the present disclosure is the information provision method according to any one of Aspects 1 to 7, in which when the first function is a driving function of the first vehicle, the countermeasure includes a third countermeasure that disables the driving function.

Thus, in the event of an attack on the driving function, the driving function of the first vehicle being attacked can be automatically disabled. Thus, an unanticipated motion control can be prevented from being executed on the first vehicle.

An information provision method according to Aspect 9 of the present disclosure is the information provision method according to any one of Aspects 1 to 8, in which the one or more second functions are set according to an administrator that manages the first vehicle.

Thus, the function that has no impact on the driving functions and is to be disabled when attacked can be set on conditions set according to the administrator.

An information provision device according to Aspect 10 of the present disclosure is an information processing device that: obtains attack information through communication with a security monitoring device that determines presence or absence of an attack based on log information obtained from a vehicle; and provides an instruction that causes an attacked vehicle to take a countermeasure appropriate to the attack. The information processing device includes: a processor; and a memory, in which the processor, by using the memory: receives attack information from the security monitoring device, the attack information including a first function of a first vehicle targeted for an attack and vehicle information for identifying the first vehicle; and transmits, to the first vehicle identified by the vehicle information, an instruction that causes the first vehicle to take a countermeasure determined according to the first function, and when the first function is a function included in one or more second functions, which are not a driving function of the first vehicle, the countermeasure includes a first countermeasure for disabling the first function while keeping the driving function active.

With this, when the first function of the first vehicle targeted for an attack is included in the one or more second functions, which are not the driving functions, the first vehicle can be caused to take a countermeasure for disabling the first function while keeping the driving functions active. That is, in the event of an attack that has no impact on the driving functions of the first vehicle, the first vehicle can continue operation (motion).

It is to be noted that these general and specific aspects may be implemented using a system, a method, an integrated circuit, computer program, or a computer readable non-transitory recording medium such as a CD-ROM, or any combination of systems, methods, integrated circuits, computer programs, or non-transitory recording media.

Hereinafter, the specific example of an information provision method and an information processing device according to one aspect of the present disclosure is described with reference to the drawings.

It is to be noted that the embodiment described here is one specific example of the present disclosure. Accordingly, the numerical values, shapes, structural elements, the arrangement and connection form of the structural elements, steps, the processing order of the steps, etc. shown in the following embodiment are mere examples, and thus are not intended to limit the present disclosure. Among the structural elements described in the following embodiment, structural elements not recited in any one of the independent claims each indicating the top concept are optional.

### EMBODIMENT

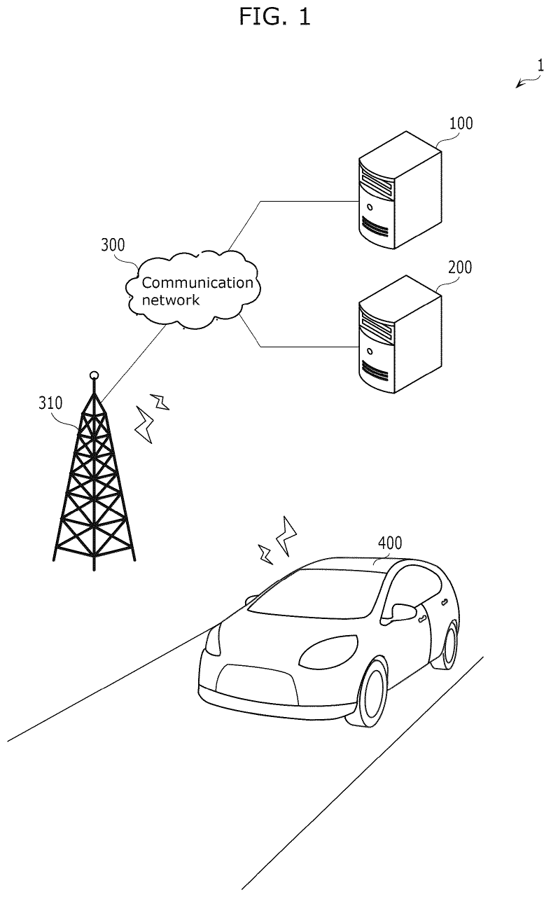

In the following, an embodiment will be described with reference to FIGS. 1 to 13.

### Configuration

FIG. 1 is a schematic diagram illustrating an information provision system that provides information to a vehicle according to an embodiment.

Specifically, FIG. 1 illustrates security monitoring device 100, information processing device 200, vehicle 400, communication network 300, and base station 310 of a mobile communication network. Security monitoring device 100, information processing device 200, and vehicle 400 are communicatively connected to each other via communication network 300 so that security monitoring device 100, information processing device 200, and vehicle 400 can exchange information.

Security monitoring device 100 is a device that monitors a state of vehicle 400, and is disposed in a monitoring center, for example. Security monitoring device 100 periodically obtains log information from vehicle 400, and monitors the state of vehicle 400 based on the obtained log information. Specifically, security monitoring device 100 determines the presence or absence of a security attack on vehicle 400 based on the log information. By reducing time to next obtainment of the log information from vehicle 400, security monitoring device 100 can determine the presence or absence of a security attack on vehicle 40 substantially in real time. If determining the presence of a security attack on vehicle 400, security monitoring device 100 transmits attack information obtained from the determination to information processing device 200.

Note that although FIG. 1 illustrates one vehicle 400, information provision system 1 may include a plurality of vehicles 400. That is, security monitoring device 100 may periodically obtain log information from each of a plurality of vehicles 400, determine the presence or absence of a security attack on each vehicle 400, and transmit attack information obtained from each vehicle 400 to information processing device 200. Security monitoring device 100 generates attack information if determining the presence of a security attack on vehicle 400, and does not generate attack information if determining the absence of a security attack on vehicle 400. Security monitoring device 100 is implemented by a computer, such as a server.

Information processing device 200 is a device that manages operations of vehicle 400. Information processing device 200 obtains an operation status of vehicle 400 from vehicle 400, and manages the operation status of vehicle 400. In the event of a security attack on vehicle 400, information processing device 200 transmits an instruction appropriate to the security attack to vehicle 400. For example, information processing device 200 determines an instruction for each vehicle based on the received attack information for each vehicle, and transmits the determined instruction to the vehicle corresponding to the attack information. Information processing device 200 is implemented by a computer, such as a server.

Vehicle 400 is an automated vehicle capable of autonomous driving. Vehicle 400 includes presenter that presents information. Vehicle 400 controls operations of vehicle 400 according to a received instruction. Specifically, vehicle 400 may present information to presenter according to the instruction or control an operation related to motion of vehicle 400 (referred to as a motion operation, hereinafter). Vehicle 400 may be a vehicle used for a car sharing service or may be a vehicle used for a taxi service, for example. Vehicle 400 may be an automated vehicle capable of autonomous driving.

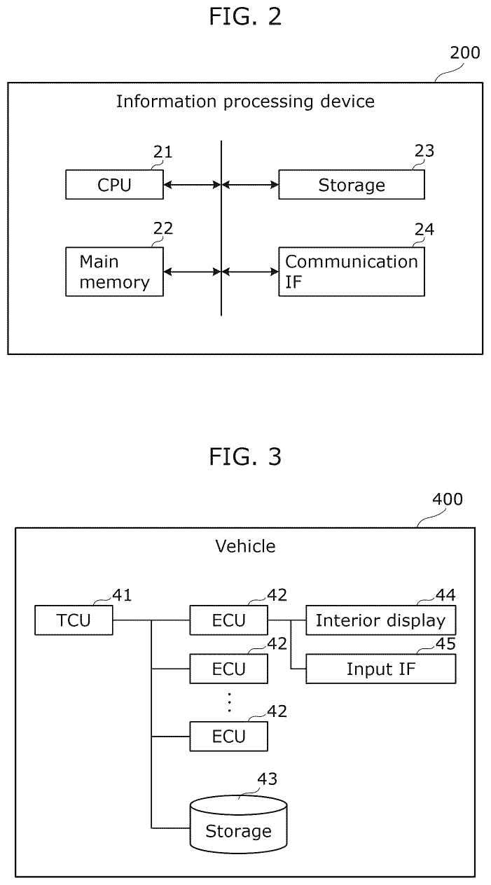

FIG. 2 is a block diagram illustrating an example of a hardware configuration of the information processing device according to the embodiment.

As illustrated in FIG. 2, information processing device 200 has a hardware configuration that includes central processing unit 21, main memory 22, storage 23, and communication interface (IF) 24.

CPU 21 is a processor that executes a control program stored in, for example, storage 23.

Main memory 22 is a volatile storage area used as a work area when CPU 21 executes the control program.

Storage 23 is a nonvolatile storage area that holds the control program and a content, for example.

Communication IF 24 is a communication interface for communicating with security monitoring device 100 or vehicle 400 via communication network 300. Communication IF 24 is a wired LAN interface, for example. Note that communication IF 24 may be a wireless LAN interface. Furthermore, communication IF 24 is not limited to a LAN interface, and can that can establish a be any communication interface communication connection with communication network 300.

FIG. 3 is a block diagram illustrating an example of a hardware configuration of the vehicle according to the embodiment.

As illustrated in FIG. 3, as hardware components, vehicle 400 includes telematics control unit (TCU) 41, a plurality of electronic control units (ECUs) 42, storage 43, interior display 44, and input interface (IF) 45.

TCU 41 is a communication unit that enables vehicle 400 to perform wireless communication with communication network 300. TCU 41 is a communication unit including a cellular module that meets a mobile communication network standard.

The plurality of ECUs 42 are control circuits that control interior display 44 included in vehicle 400 or other devices included in vehicle 400. Examples of the other devices include an engine, a motor, a meter, a transmission, brakes, a steering wheel, power windows, and an air conditioner. Furthermore, at least one of the plurality of ECUs 42 is a control circuit that controls the autonomous driving of vehicle 400. The plurality of ECUs 42 may be provided corresponding to these devices, each ECU 42 being provided per device. Although not illustrated in this drawing, each of the plurality of ECUs 42 may have a storage unit (nonvolatile storage area) that stores a program to be executed by ECU 42. The storage unit is a nonvolatile memory, for example.

Storage 43 is a nonvolatile storage area that holds a control program or the like. Storage 43 is implemented by a hard disk drive (HDD) or a solid stated drive (SSD), for example.

Interior display 44 is disposed in a cabin of vehicle 400 and displays information expressed by characters or symbols to a user in the cabin. Interior display 44 may display an image. Interior display 44 is a liquid crystal display, an organic electroluminescent (EL) display, or the like.

Input IF 45 is disposed in the cabin of vehicle 400 and receives an input (operation) from the user in the cabin. Input IF 45 may be a touch panel disposed on a surface of interior display 44 or a touch pad disposed within reach of the user seated in a seat in vehicle 400, for example.

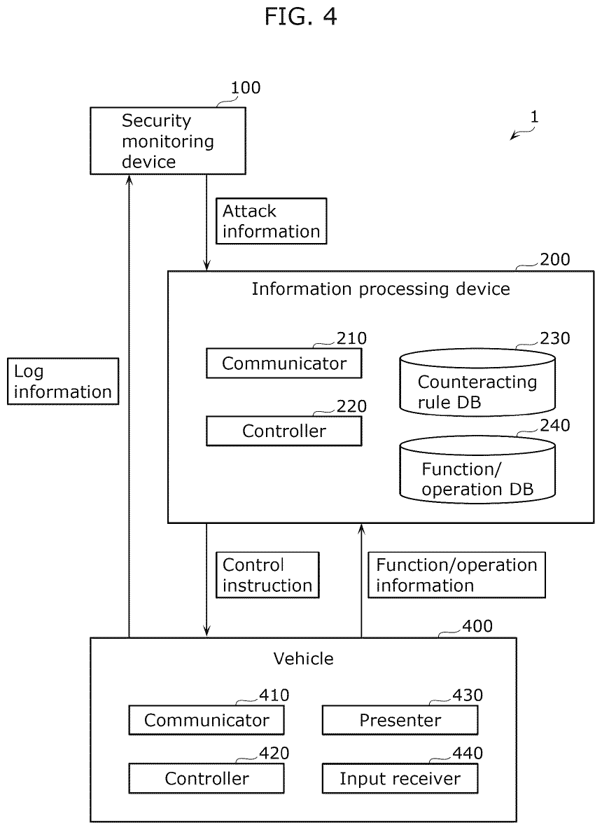

Next, functional configurations of information processing device 200 and vehicle 400 of information provision system 1 will be described. FIG. 4 is a block diagram illustrating an example of a functional configuration of the information provision system according to the embodiment. Note that communication network 300 is omitted in FIG. 4.

First, a functional configuration of information processing device 200 will be described.

Information processing device 200 includes communicator 210, controller 220, counteracting rule database (DB) 230, and function/operation database (DB) 240.

Communicator 210 transmits and receives information to and from security monitoring device 100 via communication network 300. To be more specific, communicator 210 receives attack information from security monitoring device 100. Note that communicator 210 is implemented by Communication IF 24.

The attack information is information including a function of vehicle 400 targeted for an attack (referred to as an “attacked function”, hereinafter) and vehicle information for identification of vehicle 400. The vehicle information is identification information that indicates vehicle 400 targeted for a security attack, that is, vehicle 400 detected as being under a security attack. The attacked function is an example of a first function.

Note that the attacked function included in the attack information may be associated with a threat level. The threat level is an index that indicates the threat level of the security attack on vehicle 400. The threat level is information for ranking types of security attacks according to the levels of security attacks. The threat level may be determined according to the attacked function, for example.

Note that vehicle 400 targeted for a security attack is an example of a first vehicle.

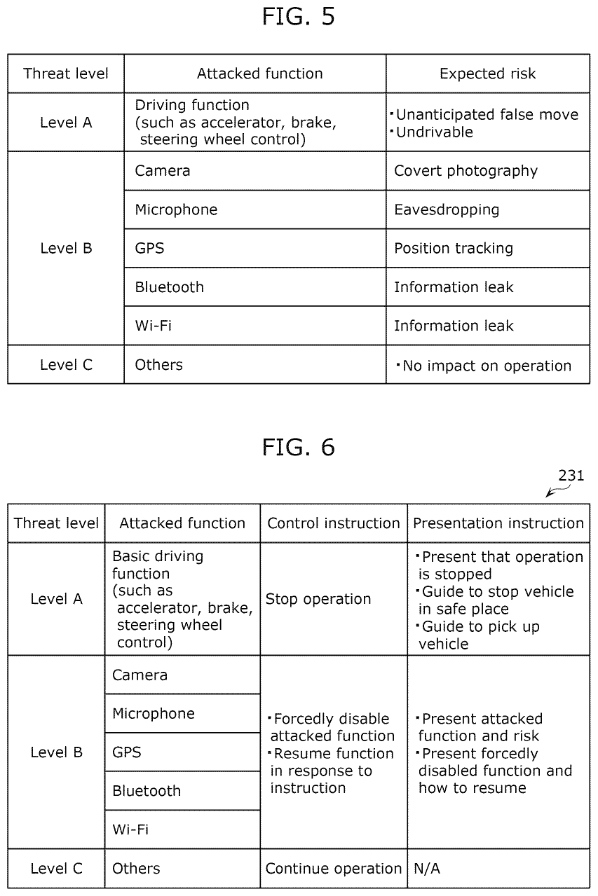

FIG. 5 is a table for describing an association between threat levels and types of security attacks.

For example, the threat level of the security attack may be ranked in three levels including: threat level A that is the highest, threat level B that is the second highest following threat level A, and threat level C that is the lowest.

Examples of the security attack at level A include a security attack that is expected to incur a risk of leading vehicle 400 to make an unexpected false move or leading vehicle 400 to be undrivable. In other words, the security attack at level A is a security attack on a driving function of vehicle 400 (accelerator, brake, or steering wheel control function). Examples of the security attack at level B include a security attack that leads vehicle 400 to suffer performance degradation. The security attack that leads to performance degradation is a security attack that is expected to incur a risk of covert photography, eavesdropping, position tracking, information leak, and the like. In other words, the security attack at the level B is a security attack on a function other than the driving functions of vehicle 400 (camera, microphone, global positioning system (GPS), Bluetooth, or Wi-Fi function, for example). These functions targeted for the security attack at level B are examples of one or more second functions. Examples of the security attack at level C include a security attack that has no impact on the operation of vehicle 400.

Communicator 210 transmits and receives information to and from vehicle 400 via communication network 300. Specifically, communicator 210 transmits an instruction for vehicle 400 to vehicle 400. Examples of the instruction include an instruction that causes vehicle 400 identified by the vehicle information to take a countermeasure determined according to the attacked function. When the attacked function is a function other than the driving functions of vehicle 400, the countermeasure includes a first countermeasure for disabling the attacked function while keeping the driving functions active. The first countermeasure includes forcedly disabling the attacked function. When the attacked function is a driving function of vehicle 400, the countermeasure may include a third countermeasure for disabling the driving function.

The countermeasure may further include a second countermeasure for causing presenter 430 included in vehicle 400 to present function information indicating the attacked function. The second countermeasure may further include, after forcedly disabling the attacked function, causing presenter 430 to present a first user interface (UI) for receiving, from the user of vehicle 400 via the input interface, an instruction for resuming the attacked function. The first UI will be described in detail later.

Controller 220 determines an instruction that is to be transmitted to vehicle 400, based on the threat level included in the attack information received by communicator 210 and the counteracting rule stored in counteracting rule DB 230. Controller 220 may determine the instruction that is to be transmitted to vehicle 400, based on a function activation history stored in function/operation DB 240 in addition to the threat level and the counteracting rule. Controller 220 generates the instruction for vehicle 400 identified by the vehicle information included in the attack information. Note that controller 220 is implemented by CPU 21, main memory 22, and storage 23, for example.

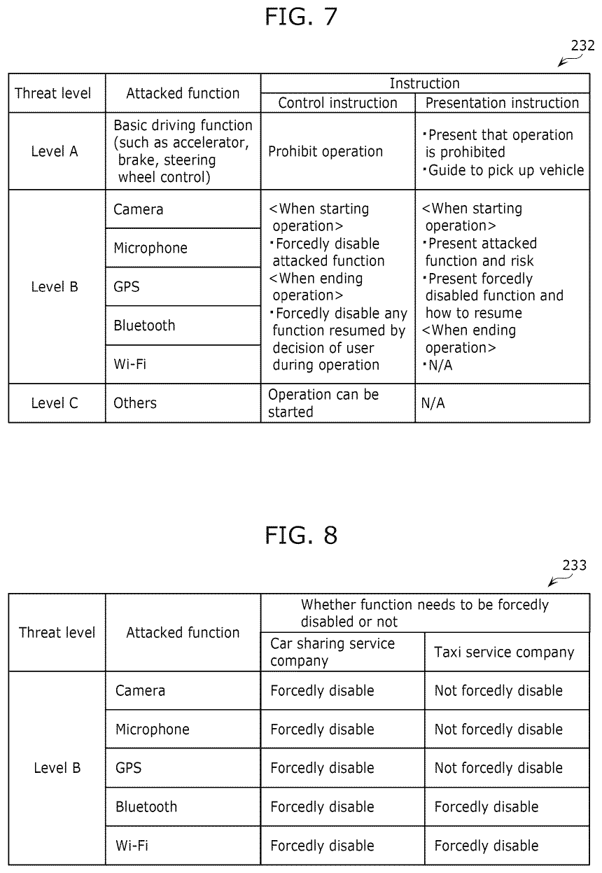

Counteracting rule DB 230 stores counteracting rule 231 illustrated in FIG. 6 and counteracting rule 232 illustrated in FIG. 7. Note that counteracting rule DB 230 is implemented by storage 23, for example.

FIG. 6 is a table showing an example of a counteracting rule for a first vehicle in operation targeted for a security attack. As described above, vehicle 400 is a specific example of the first vehicle.

Counteracting rule 231 for the first vehicle defines the instruction for the first vehicle depending on the threat level of the security attack. Specifically, when the first vehicle is in operation, based on the attack information, controller 220 refers to counteracting rule 231 in counteracting rule DB 230 and generates an instruction for vehicle 400 targeted for the security attack. Specifically, counteracting rule 231 indicates control instructions to be generated against security attacks at threat levels A to C.

For example, against a security attack at threat level A on vehicle 400, counteracting rule 231 includes a rule by which controller 220 generates an instruction including: a control instruction for stopping operation (that is, a disable instruction for a driving function); and a presentation instruction for the function information indicating the disabled function (that is, an instruction for presenting that the operation is halted). Note that the presentation instruction in this case may include a guide for picking up vehicle 400.

For example, against a security attack at threat level B on vehicle 400, counteracting rule 231 includes a rule by which controller 220 generates an instruction including: a control instruction for forcedly disabling the attacked function; and a presentation instruction for the function information indicating the disabled function. Against the security attack at threat level B on vehicle 400, counteracting rule 231 may further include a control instruction for resuming the forcedly disabled function in response to a resume instruction from the user. Against the security attack at security level B on vehicle 400, counteracting rule 231 may further include a presentation instruction for presenting the UI (first UI) for receiving, from the user, an instruction for resuming the forcedly disabled function.

For example, against a security attack at threat level Con vehicle 400, counteracting rule 231 includes a rule by which controller 220 generates a control instruction including an operation continuation instruction.

FIG. 7 is a table showing an example of a counteracting rule for the first vehicle before operation (not in operation) targeted for a security attack. As described above, vehicle 400 is a specific example of the first vehicle.

As with counteracting rule 231, counteracting rule 232 for the first vehicle defines the instruction for the first vehicle depending on the threat level of the security attack. Specifically, when the first vehicle is before operation (not in operation), based on the attack information, controller 220 refers to counteracting rule 232 in counteracting rule DB 230 and generates an instruction for vehicle 400 targeted for the security attack. Specifically, counteracting rule 232 indicates control instructions to be generated against security attacks at threat levels A to C.

For example, against a security attack at threat level A on vehicle 400, counteracting rule 232 includes a rule by which controller 220 generates an instruction including: a control instruction for prohibiting operation (that is, a disable instruction for a driving function); and a presentation instruction for the function information indicating the disabled function (that is, an instruction for presenting that the operation is prohibited). In this case, upon performing the control according to the control instruction, vehicle 400 becomes unable to receive an input (operation) to start operation from the user. That is, vehicle 400 does not start operating even if the user performs the input (operation) to start operation.

For example, against a security attack at threat level B on vehicle 400, counteracting rule 232 includes a rule by which controller 220 generates an instruction including: a control instruction for forcedly disabling the attacked function; and a presentation instruction for the function information indicating the disabled function. For example, the control instruction in this case is an instruction that causes vehicle 400 to forcedly disable the attacked function when vehicle 400 starts operation, or an instruction that causes vehicle 400 to forcedly disable any function resumed by decision of the user during operation of vehicle 400 when vehicle 400 ends operation. Against the security attack at security level B on vehicle 400, counteracting rule 232 may further include a presentation instruction for presenting the UI (first UI) for receiving an instruction for resuming the forcedly disabled function from the user when vehicle 400 starts operation. The presentation instruction in the event of the security attack at level B on vehicle 400 need not be issued when vehicle 400 ends operation, and may be issued only when vehicle 400 starts operation, for example.

For example, against a security attack at threat level Con vehicle 400, counteracting rule 232 includes a rule by which controller 220 generates a control instruction including an operation start instruction.

The rules illustrated in FIGS. 6 and 7 that define the functions to be forcedly disabled in the event of a security attack at level B may be set according to an administrator (service providing company) that manages vehicle 400.

FIG. 8 is a table showing an example of a counteracting rule about functions that are forcedly disabled in the event of the security attack at level B on the first vehicle in operation, the counteracting rule being set according to the administrator.

In the case of a car sharing service company (first administrator), for example, counteracting rule 233 set according to the administrator may define camera, microphone, global positioning system (GPS), Bluetooth, and Wi-Fi functions as functions to be forcedly disabled in the event of the security attack at level B on the first vehicle in operation. That is, for a vehicle owned by the car sharing service company, counteracting rule 233 is a rule for generating a control instruction for forcedly disabling the attacked function when any of camera, microphone, GPS, Bluetooth, and Wi-Fi functions is attacked.

In the case of a taxi service company (second administrator), for example, counteracting rule 233 may define GPS, Bluetooth, and Wi-Fi functions, excluding camera and microphone functions, as functions to be forcedly disabled in the event of the security attack at level B on the first vehicle in operation. That is, for a vehicle owned by the taxi service company, counteracting rule 233 is a rule for generating a control instruction for forcedly disabling the attacked function when any of GPS, Bluetooth, and Wi-Fi functions is attacked and for not forcedly disabling camera and microphone functions even if camera and microphone functions are attacked.

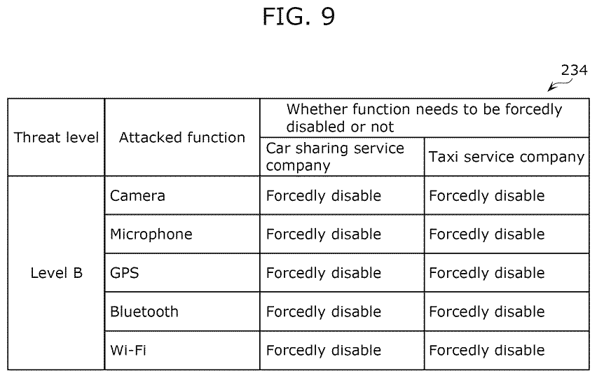

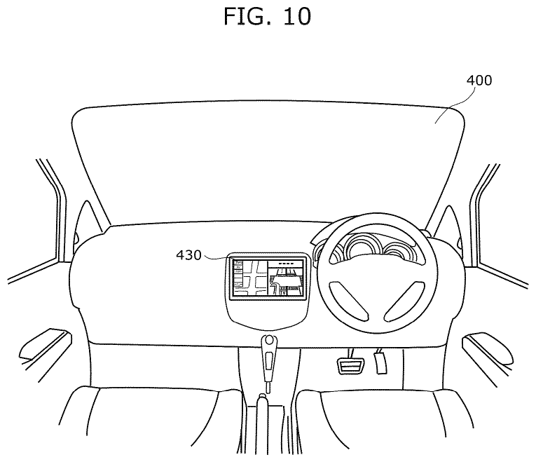

FIG. 9 is a table showing an example of a counteracting rule about functions that are forcedly disabled in the event of the security attack at level B on the first vehicle before operation (not in operation), the counteracting rule being set according to the administrator.

Counteracting rule 234 set according to the administrator may define camera, microphone, GPS, Bluetooth, and Wi-Fi functions as functions to be forcedly disabled in the event of the security attack at level B, whether the administrator is the car sharing service company (first administrator) or the taxi service company. That is, for a vehicle owned by the car sharing service company or the taxi service company, counteracting rule 234 is a rule for generating a control instruction for forcedly disabling the attacked function when any of camera, microphone, GPS, Bluetooth, and Wi-Fi functions is attacked.

Function/operation information obtained from vehicle 400 is recorded in function/operation DB 240. The function/operation information is information indicating an operational state of each of a plurality of functions of vehicle 400. The operational state is information indicating whether the relevant function is active or not. The function/operation information may associate the operational state with the time at which the operational state is detected.

By reference to function/operation DB 240, controller 220 can grasp the operational state of each of the plurality of functions of vehicle 400 targeted for an attack. Controller 220 may generate a control instruction for disabling a function for an active function according to counteracting rule 231 or 232, but need not generate a control instruction for disabling a function for an inactive function even if the function is a function to be disabled according to counteracting rule 231 or 232. In such a case, controller 220 may transmit, to vehicle 400, a presentation instruction for presenting function information indicating the attacked function, but need not transmit control information to vehicle 400.

Next, a functional configuration of vehicle 400 is described.

Vehicle 400 includes communicator 410, controller 420, presenter 430, and input receiver 440.

Communicator 410 transmits and receives information to and from security monitoring device 100 via communication network 300. To be more specific, communicator 410 transmits log information to security monitoring device 100. For example, the log information indicates a control status of vehicle 400 or a detection value of a sensor included in vehicle 400. Furthermore, communicator 410 transmits and receives information to and from information processing device 200 via communication network 300. To be more specific, communicator 410 transmits operation status information to information processing device 200. Furthermore, communicator 410 receives an instruction for vehicle 400 from information processing device 200. Note that communicator 410 is implemented by TCU 41.

Controller 420 controls an operation of vehicle 400 according to the instruction received by communicator 410. For example, when the instruction includes an instruction for stopping the motion of vehicle 400, controller 420 stops the motion of vehicle 400. For example, when the instruction includes a presentation instruction, controller 420 causes presenter 430 to present the content included in the presentation instruction. Controller 420 is implemented by the plurality of ECUs 42, for example.

Furthermore, controller 420 generates, at a plurality of different timings, function/operation information that indicates whether each of the plurality functions of vehicle 400 is active or not, and transmits the function/operation information to information processing device 200 via communicator 410. The plurality of different timings may be timings at predetermined time intervals, or may be timings at which a predetermined event occurs. The predetermined event is a change of the detection result from a predetermined sensor or a reception of information from the outside by communicator 410, for example.

Presenter 430 is disposed in the cabin of vehicle 400. Presenter 430 is implemented by interior display 44.

Input receiver 440 receives an input (operation) from the user. Input receiver 440 is implemented by input IF 45.

FIG. 10 is a diagram illustrating an example of placement of the interior display of the vehicle according to the embodiment.

As illustrated in FIG. 10, interior display 44 may be disposed in front of the driver's seat (on the dashboard, for example) in vehicle 400.

Note that interior display 44 may be implemented by a head-up display projected on the windshield of vehicle 400.

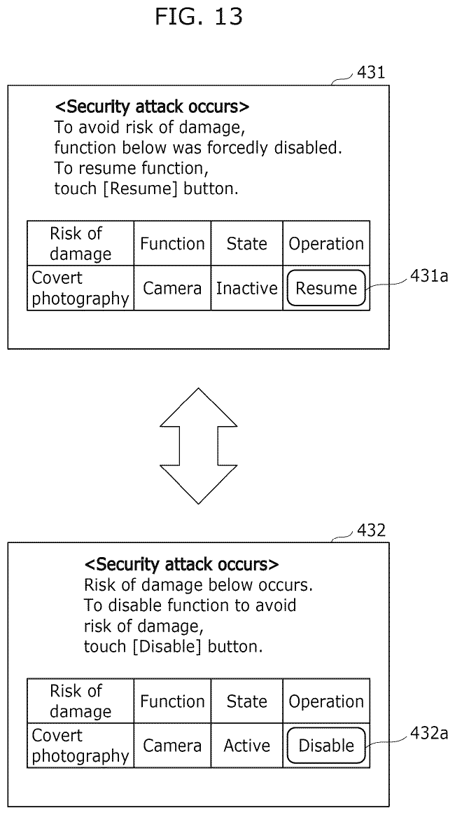

FIG. 13 is a diagram illustrating an example of the UI presented on the interior display according to the presentation instruction according to the embodiment.

Presenter 430 displays UI 431 when an instruction including a presentation instruction for function information indicating a disabled function is received by communicator 410. UI 430 shows that a security attack has occurred, and the function targeted for the security attack has been disabled. Furthermore, UI 431 may include resume button 431a for receiving, from the user, an instruction for resuming the forcedly disabled function. Resume button 431a is an example of a first UI. Furthermore, UI 431 may include information indicating the risk of damage expected in the case where the attacked function is active. When an input is made to resume button 431a, controller 420 resumes the disabled function.

Furthermore, when the input to resume button 431a is received, presenter 430 displays UI 432. UI 432 shows that a security attack has occurred, and the function targeted for the security attack is active. Furthermore, UI 432 may include disable button 432a for receiving, from the user, an instruction for disabling the function targeted for the security attack. When an input is made to disable button 432a, controller 420 disables the active function.

### Operation

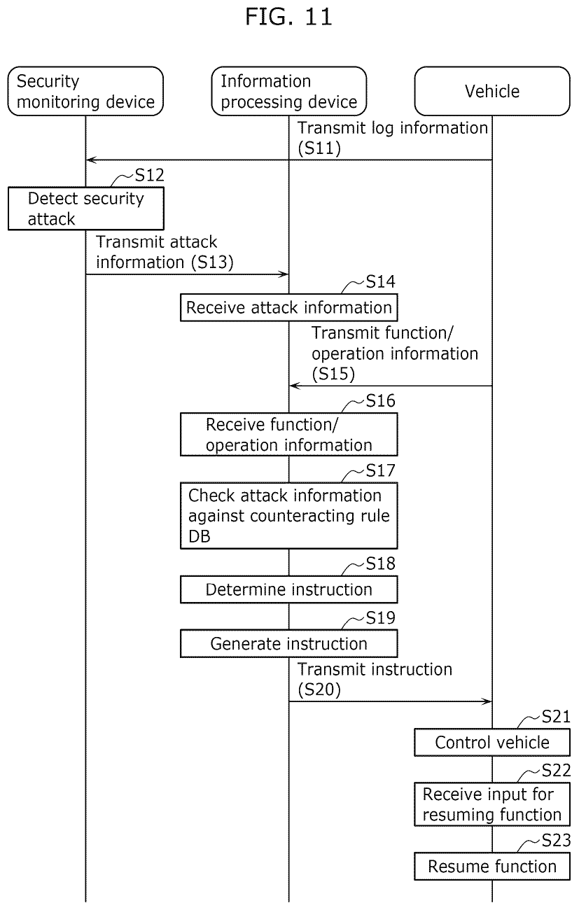

FIG. 11 is a sequence diagram illustrating an example of an information provision method executed by the information provision system according to the embodiment. FIG. 11 illustrates an example of the method executed using counteracting rules 231 and 232.

Vehicle 400 transmits log information to security monitoring device 100 (S11).

Security monitoring device 100 detects the presence of a security attack on vehicle 400, based on the log information (S12).

Security monitoring device 100 transmits, to information processing device 200, attack information that includes the function of vehicle 400 targeted for the attack (attacked function) and vehicle information for identifying vehicle 400 (S13).

Information processing device 200 receives the attack information (S14).

Vehicle 400 transmits function/operation information (S15).

Information processing device 200 receives the function/operation information (S16).

Note that step S13 and step S15 are not limited to this order, and step S15 may be performed before step S13, or step S13 and step S15 may be performed at the same time.

After step S16, information processing device 200 checks the attack information against counteracting rule DB 230 (S17).

Based on the vehicle information included in the attack information, information processing device 200 then may determine the operation status of vehicle 400 by reference to function/operation DB 240. Based on the attacked function included in the attack information and the determined operation status, information processing device 200 determines an instruction for vehicle 400 by reference to counteracting rule DB 230 (S18).

Information processing device 200 then generates the determined instruction (S19).

Information processing device 200 transmits the generated instruction to vehicle (S20).

Upon receiving the instruction, vehicle 400 controls vehicle 400 according to the instruction (S21). For example, if the instruction includes forced disabling of the camera and presentation thereof, vehicle 400 forcedly disables the function of the camera, and causes presenter 430 to present function information indicating the forcedly disabled function.

Then, when vehicle 400 receives, from the user, an input for resuming the forcedly disabled function (S22), vehicle 400 resumes the forcedly disabled function (S23).

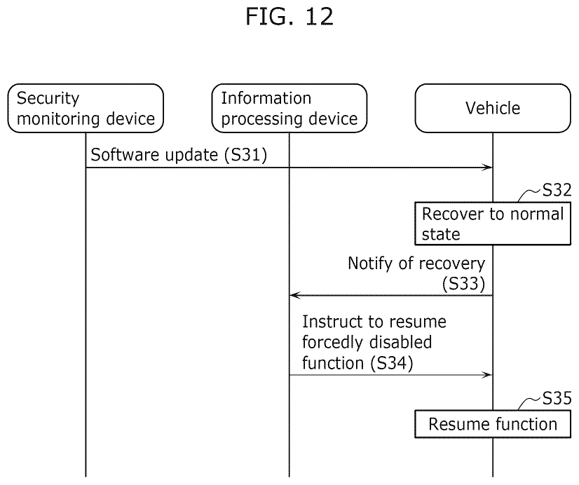

FIG. 12 is a sequence diagram illustrating an example of an operation in recovery executed by the information provision system according to the embodiment.

Security monitoring device 100 transmits, to vehicle 400, software updating data for eliminating the vulnerability of the security-attacked function (S31).

Upon receiving the software updating data, vehicle 400 performs software update using the data to recover to the normal state (S32). In this step, vehicle 400 does not resume the forcedly disabled function.

After recovering to the normal state, vehicle 400 notifies information processing device 200 that vehicle 400 has recovered to the normal state (S33).

Upon receiving the recovery notification from vehicle 400, information processing device 200 transmits, to vehicle 400, an instruction for resuming the function forcedly disabled in response to the attack (S34).

Upon receiving the instruction for resuming, vehicle 400 resumes the forcedly disabled function (S35).

### Advantageous Effects Etc.

An information provision method according to the present embodiment is executed by information processing device 200 that: obtains attack information through communication with security monitoring device 100, which determines the presence or absence of an attack based on log information obtained from vehicle 400; and provides an instruction that causes attacked vehicle 400 (first vehicle) to take a countermeasure against the attack. Information processing device 200 receives, from security monitoring device 100, attack information that includes an attacked function (first function) of vehicle 400 targeted for an attack and vehicle information for identifying the vehicle. Information processing device 200 transmits, to vehicle 400 identified by the vehicle information, an instruction that causes vehicle 400 to take a countermeasure determined according to the attacked function. When the attacked function is included in the one or more second functions of vehicle 400, which are not the driving functions, the countermeasure includes a first countermeasure for disabling the first function while keeping the driving functions active.

With this, when the first function of the first vehicle targeted for the attack is included in the one or more second functions, which are not the driving functions, the first vehicle can be caused to take a countermeasure for disabling the first function while keeping the driving functions active. That is, in the event of an attack that has no impact on the driving functions of the first vehicle, the first vehicle can continue operation (motion) while avoiding the risk due to the attack.

Furthermore, in the information provision method according to the present embodiment, the first countermeasure includes forcedly disabling the attacked function. Therefore, the risk due to the attack can be avoided.

Furthermore, in the information provision method according to the present embodiment, the countermeasure further includes a second countermeasure for causing presenter 430 included in vehicle 400 to present function information indicating the attacked function. Therefore, the user can recognize the function disabled to avoid the risk due to the attack.

Furthermore, in the information provision method according to the present embodiment, the second countermeasure includes, after forcedly disabling the attacked function, causing presenter 430 to present the first UI for receiving an instruction for resuming the attacked function from the user of vehicle 400 via input IF 45 included in vehicle 400. Therefore, the user can know the risk due to the attack and continue using the attacked function.

Furthermore, in the information provision method according to the present embodiment, when the attacked function is a driving function of vehicle 400, the countermeasure includes a third countermeasure for indicating to disable the driving function. Therefore, an unanticipated motion control can be prevented from being executed on the first vehicle.

Furthermore, in the information provision method according to the present embodiment, the one or more second functions, which are not the driving functions, are set according to the administrator that manages vehicle 400. Therefore, the function that has no impact on the driving functions and is to be disabled when attacked can be set on conditions set according to the administrator.

### Variations

1

In the embodiment above, in the event of a security attack at level B, controller 220 generates an instruction for forcedly disabling the attacked function. However, this is not intended to be limiting. For example, controller 220 may generate an instruction that causes vehicle 400 to take the first countermeasure. The first countermeasure includes causing presenter 430 included in vehicle 400 to present a second UI for receiving, from the user of vehicle 400 via input IF 45, an instruction for disabling the function targeted for the security attack at level B. Therefore, the user can choose whether to disable the attacked function or not.

The second UI in this case may be UI 432 in FIG. 11. That is, the second UI further includes risk information that presents risks in the case where the attacked function is not disabled. Therefore, the user can recognize the risks due to the attack.

Furthermore, the first countermeasure may further include, after disabling the attacked function, causing presenter 430a to present a third UI for receiving, from the user of vehicle 400 via input IF 45, an instruction for resuming the attacked function. The third UI in this case may be UI 431 in FIG. 11. Therefore, the user can choose to resume the attacked function.

2

In the embodiment above, presenter 430 included in vehicle 400 is a display that displays information. However, this is not intended to be limiting. Presenter 430 may be a speaker that outputs information by sound.

3

In the embodiment above, security monitoring device 100 generates no attack information in the absence of a security attack. However, this is not intended to be limiting. Regardless of the presence or absence of a security attack, the attack information indicating the presence or absence of a security attack on vehicle 400 may be generated. To be more specific, when determining the presence of a security attack on vehicle 400, security monitoring device 100 may generate attack information including information indicating the presence of a security attack. And when determining the absence of any security attack, security monitoring device 100 may generate attack information including information indicating the absence of any security attack.

4

It is to be noted that, in the embodiment described above, each of the constituent elements may be configured in the form of an exclusive hardware product, or may be realized by executing a software program suitable for each structural element. Each of the constituent elements may be realized by means of a program executing unit, such as a CPU and a processor, reading and executing the software program recorded on a recording medium such as a hard disk or a semiconductor memory. Here, the software which implements information processing device 200 according to the embodiment as described above is a program indicated below.

In other words, this program causes a computer to execute an information provision method executed by an information processing device that: obtains attack information through communication with a security monitoring device that determines presence or absence of an attack based on log information obtained from a vehicle; and provides an instruction that causes an attacked vehicle to take a countermeasure appropriate to the attack. The information provision method includes: receiving attack information from the security monitoring device, the attack information including a first function of a first vehicle targeted for an attack and vehicle information for identifying the first vehicle; and transmitting, to the first vehicle identified by the vehicle information, an instruction that causes the first vehicle to take a countermeasure determined according to the first function, in which when the first function is a function included in one or more second functions, which are not a driving function of the first vehicle, the countermeasure includes a first countermeasure for disabling the first function while keeping the driving function active.

Although the information processing method according to one or more aspects of the present disclosure has been described above based on the embodiment, the present disclosure is not limited to the embodiment. Various modifications of the embodiment as well as embodiments resulting from arbitrary combinations of the structural elements of the embodiment that may be conceived by those skilled in the art are intended to be included within the scope of one or more aspects as long as these do not depart from the essence of the present disclosure.

While various embodiments have been described herein above, it is to be appreciated that various changes in form and detail may be made without departing from the spirit and scope of the present disclosure as presently or hereafter claimed.

### FURTHER INFORMATION ABOUT TECHNICAL BACKGROUND TO THIS APPLICATION

The disclosures of the following patent applications including specification, drawings, and claims are incorporated herein by reference in their entirety: PCT International Application No. PCT/JP2023/026470 filed on Jul. 19, 2023, and Japanese Patent Application No. 2022-180736 filed on Nov. 11, 2022.

### INDUSTRIAL APPLICABILITY

The present disclosure is useful as an information provision method and the like that allow an attacked vehicle to continue operation (motion) while notifying the user of the vehicle of the risk due to the attack or by taking a countermeasure against the attack when the attack has no impact on the driving functions of the vehicle.

1. An information provision method executed by an information processing device that: obtains attack information through communication with a security monitoring device that determines presence or absence of an attack based on log information obtained from a vehicle; and provides an instruction that causes an attacked vehicle to take a countermeasure appropriate to the attack, the information provision method comprising:
receiving attack information from the security monitoring device, the attack information including a first function of a first vehicle targeted for an attack and vehicle information for identifying the first vehicle; and
transmitting, to the first vehicle identified by the vehicle information, an instruction that causes the first vehicle to take a countermeasure determined according to the first function,
wherein when the first function is a function included in one or more second functions, which are not a driving function of the first vehicle, the countermeasure includes a first countermeasure for disabling the first function while keeping the driving function active.

2. The information provision method according to claim 1, wherein the first countermeasure includes forcedly disabling the first function.

3. The information provision method according to claim 2, wherein the countermeasure further includes a second countermeasure that causes a presenter included in the first vehicle to present function information that indicates the first function.

4. The information provision method according to claim 3, wherein the second countermeasure further includes, after forcedly disabling the first function, causing the presenter to present a first user interface (UI) for receiving, from a user of the first vehicle via an input interface included in the first vehicle, an instruction for resuming the first function.

5. The information provision method according to claim 1, wherein the first countermeasure includes causing a presenter included in the first vehicle to present a second user interface (UI) for receiving, from a user of the first vehicle via an input interface included in the first vehicle, an instruction for disabling the first function.

6. The information provision method according to claim 5, wherein the first countermeasure further includes, after disabling the first function, causing the presenter to present a third user interface (UI) for receiving, from the user of the first vehicle via the input interface, an instruction for resuming the first function.

7. The information provision method according to claim 5, wherein the second UI further includes risk information for presenting a risk in a case where the first function is not disabled.

8. The information provision method according to claim 1, wherein when the first function is a driving function of the first vehicle, the countermeasure includes a third countermeasure that disables the driving function.

9. The information provision method according to claim 1, wherein the one or more second functions are set according to an administrator that manages the first vehicle.

10. An information processing device that: obtains attack information through communication with a security monitoring device that determines presence or absence of an attack based on log information obtained from a vehicle; and provides an instruction that causes an attacked vehicle to take a countermeasure appropriate to the attack, the information processing device comprising:
a processor; and
a memory,
wherein the processor, by using the memory:
receives attack information from the security monitoring device, the attack information including a first function of a first vehicle targeted for an attack and vehicle information for identifying the first vehicle; and
transmits, to the first vehicle identified by the vehicle information, an instruction that causes the first vehicle to take a countermeasure determined according to the first function, and
when the first function is a function included in one or more second functions, which are not a driving function of the first vehicle, the countermeasure includes a first countermeasure for disabling the first function while keeping the driving function active.
